(19) United States
(12) Patent Application Publication
(10) Pub. No.: US 2014/0166323 A1
(43) Pub. Date: Jun. 19, 2014

(54) Kickback Reduction for Power Tools and Machines

(71) Applicant: J. Carl Cooper, Incline Village, NV (US)

(72) Inventor: J. Carl Cooper, Incline Village, NV (US)

(21) Appl. No.: 14/027,409

(22) Filed: Sep. 16, 2013

Related U.S. Application Data
(60) Provisional application No. 61/701,680, filed on Sep. 16, 2012.

(51) Int. Cl. B23Q 11/00; F16P 3/00

(52) U.S. Cl. CPC B23Q 11/0092; F16P 3/008
USPC 173/1; 173/176

(57) ABSTRACT

An apparatus and methods are described for protecting an operator from sudden, unexpected or dangerous movement of powered hand held tools and the like. A set of parameters for safe operation of the tool are provided, which parameters may be adjusted or selected based on the manner in which the tool is being operated. The power tool is fitted with sensors including an accelerometer, operating to sense acceleration of the tool in a plurality of axes during operation. The output of the accelerometer is coupled to a computing circuit which determines if the acceleration of the tool is within the safe operation parameters. When acceleration of the tool exceeds one or more of the safe operating parameters, power to the tool motor is limited or otherwise adjusted in order to prevent or reduce the movement of the tool thereby protecting the operator.

This application claims priority to U.S. Provisional Patent Application 61/701,680 filed Sep. 16, 2012. Application 61/701,680 is hereby incorporated by reference in its entirety.

### FIELD OF THE INVENTION

The invention relates to protecting an operator and bystanders from unexpected movement of power tools and the like. Such movement commonly referred to as kickback includes sudden, unexpected, dangerous or other situations of, or potentially leading to, unwanted movement of powered tools, equipment, machines and the like, their associated components, accessories, work pieces and tools holding work pieces, as well as broken pieces or loose parts thereof. The invention finds particular usefulness with hand held power tools with sharp cutting edges which may break such as drills and saws, but is also applicable to other tools as well. The invention will find useful application with power tools and machines which are powered by a variety of energy sources including for example electricity, compressed gas, steam, hydraulic and internal combustion energy sources, which sources may be suitably arranged for portable (e.g. battery), tethered (e.g. power hose or cord) or stationary (e.g. bench or floor mounted) operation.

### BACKGROUND OF THE INVENTION

When an operator utilizes a motorized cutting or other power tool such as a drill, saw, hammer, wrench or the like, care must be taken to ensure that the tool is not pulled from the operator's hands or otherwise injures the operator or bystanders when the tool binds or sticks in the work causing kickback of the tool or throwing of the work or parts or broken pieces of the tool or work. This is particularly true for hand held tools or mounted tools with hand held accessories or work.

For purposes of the present disclosure the object which is being operated on by the power tool, device or machine will be referred to as the work piece or work and the powered device will be referred to as the power tool or tool. The work may be held directly by the operator or with the aid of one or more hand tool or accessory e.g. pliers, clamp or chuck, or the operator may hold the tool to the work, or various combinations thereof may be resorted to as will be known to one of ordinary skill in the art from the teachings herein. For example work pieces include a piece of metal being drilled by a drill, a board pushed through a table saw, a piece of metal pushed against a grinding wheel, a tree limb being cut by a chain saw. The drill, table saw, grinder and chain saw are the tools respectively. As is well known in the art the work and/or tool may be held in various combinations with the holding being accomplished directly by a body part (e.g. a hand or foot) or indirectly with the aid of a tool accessory (e.g. clamp or lever), and the work may be held to the tool or the tool to the work or a combination thereof as discussed above. One of ordinary skill will appreciate the novelty and utility of the present invention with respect to the many various combinations of tool and work operations from the teachings herein.

For example a safety issue exists when drilling in work with a hand held drill. If the drill bit sticks in the work unexpectedly the drill will tend to twist or jerk in the opposite direction (i.e. reverse torque) of the drill bit rotation, and if the force is strong enough, out of the operator's hands. If the drill jerks from the operator's hands it can injure the operator or a bystander, or cause damage to the drill, drill bit, work or surrounding items. The operator strength needed to hold the drill increases as the drill torque increases, making large horsepower or high gear reduction drills particularly troublesome. Even if the operator manages to hold the drill, it can nevertheless cause injury. This potential for injury is especially true when the drill must be held with outstretched arms, overhead or in any awkward or unusual position. If the drill is mounted to a work bench or the floor and the work is hand held or held using a tool or accessory such as pliers or clamp a similar danger exists as the bit can become stuck in the work causing the work, pliers or clamp to twist in the operator's hands or fly away.

Safety problems, injury or damage can occur with virtually any hand held tool or hand held work which has the potential to transfer injury or damage causing force to the operator, a bystander or surrounding items. Such tools include, but are not limited to, saws of various types (e.g. rotating, counter rotating, reciprocal, band), hammers, chisels, grinders, shears, wrenches, shapers, planers, sanders and the like. Problem can occur when the tool or the work is powered, for example when a hand held drill is used to drill a hole in a stationary piece or work, or when the work is chucked in a drill and held against a stationary tool. Problems also can occur when the tool or work is not powered but is utilized with a powered device. Examples include and operator pushing a board through a table saw, holding a cutting tool against the work turned by a lathe, or holding work in a drill press or against a grinder. There are also problems when both the tool and work are held, for example when a drill or saw is held in one hand and the work is held with the other hand or a foot.

There are prior art devices which are intended to help with power tool safety but these devices have problems such as with operating speed and reliability under various working conditions. For example, many hand held battery powered drills include an adjustable mechanical clutch type device which limits the torque applied to the drill chuck. These clutch devices are mainly intended to limit the torque applied to a particular tool bit which is chucked, such as a screwdriver bit, to prevent stripping screw heads. These clutch devices will also limit the reverse torque which the operator must contend with if the tool bit or screw suddenly sticks in the work. Many such clutch devices include a clutch disable setting which removes the clutch action and allows full torque developed by the motor and drive gearing to be applied to the chuck. The clutch disable setting does not protect the operator and is generally intended to be used when high torque is needed, such as for drilling holes, when protection is needed most.

U.S. Pat. No. 5,125,160 issued Jun. 30, 1992 to James Gassen provides for a mechanical chain brake for a chain saw. The abstract describes “[a]n intertial-manual actuating chain brake for a chain saw in which a mechanical integrator distinguishes between relatively long duration accelerations developed by a “kickback” producing impulse and normal operating accelerations associated with operational and vibratory forces. Occurrence of a “kickback” impulse, developing a force of required magnitude, direction, and duration causes a spring-mass accelerometer to change from a brake released to a brake applied condition, applying a braking torque to the saw chain.” The Gassen “spring-mass accelerometer utilizes a pivotable hand guard as the actuating means. The hand guard also provides for manual operation. The hand guard is comprised of a housing and an inertia weight that is connected to the housing.

The Abstract suggests the weight and type of inertia weight can be selected to provide the brake applied condition for a predetermined movement of the chain saw or for a predetermined type of chain saw. The inertia weight itself can be adjusted to adjust the accelerometer. However in the description of the preferred embodiment there is no suggestion that the weight is designed to be easily changed or otherwise adjusted in response to, or to accommodate changes in the operation of the saw in a typical work environment. For example see the description of the weight and its frame at col. 5, II. 25-54 and in particular “[t]he frame 78 has crush ribs 102 at the interior of the cavity 86 that are adapted to be deformed or partially crushed by the weight 80 when it is inserted. This aids in stationarily positioning the weight 80 relative to the frame 78. When the pin 98 is inserted into the frame 78 it is positioned adjacent the base 100 of the weight 80 and thus blocks the path of the weight 80 from inadvertently exiting the cavity 86.”

Gassen does suggest at col. 6, I. 67-col. 7, I. 10 with respect to FIG. 4, “there is shown a schematic cross-sectional view of an alternate embodiment of the present invention. In the embodiment shown, the hand guard 104 has a frame 106 with a plurality of locking pin holes 108, an inertia weight 110, and two looking pins 112. In this embodiment the pins 112 and holes 108 can be used to position the weight 110 at different locations in the frame 106 to vary or select an appropriate center of gravity for the hand guard 104. Thus, the inertia weight can be positionally adjusted to vary the actuation of the inertia switch.” At the preceding paragraph col. 6, II. 39-66 and in particular “[i]n this situation, the present invention allows a single type of frame to be used by merely providing different types of inertia weights having predetermined masses and to provide a predetermined hand guard center of gravity to match the requirements for the different kickback characteristics.” (emphasis added) (col. 6, II. 50-55).

The Gassen device may be utilized to provide a degree of protection in a situation where the chain saw is held against stationary work such as a fallen tree, but Gassen makes no provision for adjusting operation on the job with work which requires the operator to hold the saw with outstretched arms such as an overhead high tree limb, or work the operator is holding such as by using a foot to hold a branch on the ground. These situations where the operator is operating the saw in a potentially more dangerous manner than when the work is secure are not adequately addressed by the Gassen device. Gassen does not recognize the problem or otherwise provide any sort of provision for situations such as these or any other situations where the amount or direction of a dangerous “kickback” producing impulse or normal operating accelerations associated with operational and vibratory forces may be different in a typical work setting in which the tool is operated in a variety of manners. Gassen also does not make any provision for differing operator strengths and grips.

While Gassen suggests “[t]he weight and type of inertia weight can be selected to provide the brake applied condition for a predetermined movement of the chain saw or for a predetermined type of chain saw. The inertia weight can be adjusted to adjust the accelerometer.” however Gassen does not suggest or fairly teach that the weight may be adjusted on the job, or automatically to facilitate different operator strength, grip, cutting operations such as the manner in which the operator is holding the saw. In addition the selection of the weight of the Gassen accelerometer suffers from other limitations which make it undesirable for many tools. Gassen notes that the kickback is generally related to the kinetic energy of the chain which in turn relates to the speed of the chain and the nature of the engagement of the chain with the work (col. 1, II. 20-31). Many of these limitations generally apply to the use of the mechanical weight type kickback limiting taught by Gassen. Additionally Gassen utilizes a pivotable hand guard which has the potential to not perform as well as a fixed hand guard because of the difficulty of holding on to a pivotable guard as compared to a fixed guard.

The preferred embodiment Gassen device operates primarily in a single direction, i.e. in response to forces parallel to the chain motion which cause the weight to move, thus making it unsuitable for rotational forces such as those in a drill. Another problem is the additional weight that the Gassen accelerometer mass adds to the chain saw. And another problem is that the Gassen accelerometer only detects acceleration in one direction of movement in one axis (relative to the saw) and is sensitive to error introduced by the orientation of the weight and its suspension relative to the kickback forces and gravity. For example if the saw is held in a vertical direction the amount of acceleration to trip the brake is ≈1 g more or less than in the horizontal position, depending on the orientation of the weight and its suspension relative to the downward pull of gravity. As a simple example if the operator is holding (using the guard) the chainsaw vertically overhead the weight of the saw is pressing against the guard whereas if the chainsaw is being held vertically below the knees the weight of the chainsaw is pulling the guard.

Yet another problem is that the Gassen accelerometer does not take into account environmental considerations such as temperature which can affect the sensitivity of the actuating mechanism. And still another problem is that it is not adjustable automatically or by the operator for different operating conditions, e.g. hard wood vs. soft wood vs. wet wood, the position of the operator and work and the manner in which the operator holds the saw and/or work and the strength of the operator.

### SUMMARY OF THE INVENTION

What is needed is protection of the operator and others when operating a powered tool or powered machine where the positioning of the tool, machine and/or work piece may create potentially or actual dangerous situations with various operator strengths and grips and wherein such variations are easily or automatically taken into account in the work environment, coupled with measurement of the acceleration of the tool or work to allow detection of conditions which are or are potentially dangerous. The present invention provides for detection of acceleration of the tool or work in any axis (including the position of the tool relative to gravity) along with fast determination of the amount of acceleration relative to that necessary, likely to, or to potentially cause injury to the operator or bystander. In response to that determination the powered device which causes the acceleration is controlled thereby limiting speed, torque, etc. or to cause more extreme operator protection such as completely shutting down or reversing the device. The control is preferred to be automatically and/or operator adjusted to account for working environment variables, e.g. gravity, position (including operator position relative to the tool, grasp and distance from tool, environmental factors and operating conditions and the operator desired degree or level of protection. It is also desirable to allow automatic and/or operator adjustment to accommodate work conditions e.g. characteristics of the material being worked, awkward and one hand grasp of the tool, faults such as cutting tool breakage and limiting tool power output to protect the work as well as the operator in response to the work conditions.

Sensing acceleration in various directions is desired in order to facilitate recognition of various types of potential operator injury or tool damaging conditions. For example sensing the acceleration of a drill in a rotary direction opposite to the rotation of the bit or the direction of a chain, belt or band which may cause a reversed reaction. Adjusting fault detection is preferred to be responsive to operator settings which may be input via setup and/or operation, such as adjusting detection for operator programmed parameters and desired level of protection (or reaction) as well as in response to the direction of rotation or linear motion and trigger or other speed or torque control. Adjustment of response for operator grasp, stored inertia of the rotating or linear components, mass of the tool, power applied to the tool's motor(s), speed of the motor(s) and torque of the motor(s) are examples of other factors which may be taken into account. All of the above considerations may be desirable individually or in various combinations depending on the particular degree of protection vs. cost and complexity desired to achieve a defined level of performance in practicing the invention.

It will be understood that the invention may be utilized with any type of energy source known to those of ordinary skill in the art including, but not limited to battery and cord electrical, gas pressure (e.g. compressed air), fluid (e.g. hydraulic), thermal (e.g. steam), chemical (e.g. fuel cell) and mechanical (e.g. spring, flywheel), and with any type of power source, for example such as electric motors and actuators, internal combustion engines, compressed air, hydraulic and other pressure motors and actuators, spring power and linear or rotary electric or hydraulics. It will be known to the person of ordinary skill in the art from the teachings herein to utilize and adapt the invention for use with virtually any sort of tool, work or other device for which unexpected or uncontrolled motion of the tool or work may cause injury to the operator, others, the device or the work, all without resorting to undue experimentation or invention.

The preferred embodiment of the invention shown by way of example incorporates a 3 axis accelerometer which senses acceleration in the three physical axes in which the tool is operated. Those axes may be any three chosen axes as desired but for simplicity the teachings herein will be with respect to two perpendicular axes X and Z which lie in a plane perpendicular to gravity, i.e. the plane of the floor (or ground), with the third axis Y being parallel to gravity. The preferred type of accelerometer will operate to sense the acceleration of gravity, or in actuality the force of the earth transmitted by whatever is holding the tool to keep it from falling to the floor. For simplicity the accelerometer sensor will be described as responding to the acceleration of gravity and thus if the tool is held at any angle with respect to the X, Y and Z axes the accelerometer will respond to gravity at those three angles and will enable a determination thereof.

In addition to responding to the angle of gravity, the accelerometer will respond to any acceleration in any direction and will provide information about that acceleration and its component in each of the three axes. It should be kept I mind that while a power tool might be expected to kickback in a known direction, such is not always the case. For example a drill may both rotate and move tangentially to the bit rotation when the bit sticks and a chain saw may rotate about the stuck chain and move parallel to the chain. Movement may take place in totally unexpected directions, particularly when a stuck bit or chain breaks. The ability to measure accelerations which will, if left unchecked, result in such complex movement is a novel feature of the present invention.

Recall that force=mass times acceleration, F=MA (or restated F/M=A and F/A=M). Thus if the mass of the tool is known and an acceleration of the tool is known the amount of force on the tool may be calculated. It is the amount of this force which is of primary interest in maintaining safe tool operation since an operator holding the tool must be able to respond to and counteract this force before it rises to a magnitude that causes tool movement and the operator is unable to handle in a given operation. However since F=MA and the mass if the tool can be known or approximated the measurement of acceleration will suffice for the purpose of knowing the force. Recall that while the acceleration may be sudden or nearly instant, the velocity (movement) of the tool is not. Velocity=acceleration times time or V=At. If the operator has a strong grip and the tool is well controlled a large kickback force will only result in a small or moderate tool acceleration. Conversely with a poor grip or the tool is otherwise not well controlled a large kickback force will result in a small acceleration.

It will be recognized that while the acceleration of the tool is measured in the preferred embodiment, that acceleration is utilized as an estimate of the force which the tool is applying against the operator's grip coupled with how well the operator is coping with that force. For example if the tool is only accelerating slightly, thus giving rise to small velocity and distance movement, a secure grip and safe operation is likely and may be inferred in response to that acceleration. If the tool is accelerating quickly, thus giving rise to large velocity and distance movement an unsecure grip and unsafe operation is likely and may be inferred in response to that acceleration. In this manner the acceleration alone, and independent of actually knowing the tool mass and actually knowing the tool operation or operator grip, is a good measure of safe operation. If the tool mass, operation and grip are actually known it is possible to quickly know or estimate whether the tool is entering or has entered a dangerous operation which may cause or has caused the tool to be dislodged from the operator's grip. Using electronic acceleration sensor and electronic circuitry this determination may be made quicker than an operator can realize and react to the same situation.

Movement of the tool may result in the operator losing his grip on the tool which then becomes a dangerous situation. Movement also causes danger because the operator's grip on the tool must follow the movement and operator strength may diminish as the tool handle moves causing diminished grip or the operator's wrist may not be able to accommodate the movement. The movement takes time after the force causing the acceleration is applied thus if the acceleration of the tool can be quickly sensed and the force causing the acceleration quickly removed before the velocity increases to a dangerous amount (causing movement) the safety of the operator may be enhanced. Note that the above are related to linear motion similar to a simple hand held saw kickback. Rotational forces, acceleration and motion, such as that of a drill, and complex motions, are similar in concept but mathematically somewhat different. The linear treatment is used herein for simplicity.

There are a variety of accelerometer devices available which are suitable for use in the practice of the invention, some incorporate internal circuitry and output data in a known format for the acceleration in three axes directly and others merely output raw data and external circuitry is required to determine and format the acceleration data. Either type may be utilized if desired with the acceleration being used to determine both the angles to X, Y and Z at which the tool is being held with respect to gravity as well as the angle and amount of additional acceleration which results from tool operation. It is noted that a single 3 axis device may be utilized with suitable electronic circuitry to provide both sets of information by sensing gravity immediately before the tool starts working followed by sensing acceleration caused by the working. The description of the preferred embodiment of the invention given herein by way of example will speak of both angular information or data and acceleration (and/or force) information or data being provided by, or in response to the sensors. It will be understood that the actual data, e.g. the numeric value of the angle or acceleration, may come directly from the sensor or may be developed from raw sensor data by external circuitry. In addition, some angular data is preferred to be determined by attaching to or associating one or more sensors with a hand or arm, however this angle information may be obtained by other techniques as well. Of course it will be recognized that with the three axis space utilized in the instant description of the preferred embodiment a measurement in respect to a given reference e.g. the floor may be converted to a measurement in respect to a different reference e.g. gravity by mathematical operation. For example an acceleration parallel to gravity is also perpendicular to the floor.

The operator is able to withstand higher kickback forces if the tool is held near to the body with two hands than if the tool is held single handed, outstretched, overhead or at some contorted position. It is preferred that desired ones of the angles of the operator's torso, upper arm, forearm and hand are determined in three dimensional space in order to obtain a measure of the operator's ability to hold the tool or a particular working position. While the level of acceleration resulting from tool operation is a good measure of safe or unsafe operation by itself (and may be used by itself if desired) the decision as to safe or unsafe operation, or degree thereof. It is preferred however that the decision of, or degree of safe/unsafe operation be adjusted to accommodate any reduction in the operator's capabilities or ability to withstand a kickback due to the manner in which the tool is operated and the grip thereon. Accordingly, it will be understood that with respect to the preferred embodiment three types of information about the tool and operator are preferred to be obtained using accelerometers, (1) a measure of the operator's ability to hold the tool securely using angles with respect to the floor of the operator's arm(s) and hand(s) which are holding the tool, (2) a measure of the gravity adjusted kickback of the tool in the event of an unexpected failure such as a stuck drill bit using angles of the tool itself with respect to the floor, (3) the occurrence of a potentially dangerous tool operation using the acceleration of (or force thereon) the tool.

In addition the distance of the tool from the operator, distance of the tool from the floor, operator grip on the tool, operator strength and operator reaction time are also desired information for use by the preferred embodiment. The particular manner in which information or data to be utilized by the invention is developed will not be discussed in great detail as one of ordinary skill in the art will know from the teachings herein to design the sensing elements, electronic processing circuitry and input devices to provide the desired set of information or data in the desired form in order to practice the invention without resorting to undue experimentation or invention.

### BRIEF DESCRIPTION OF THE DRAWINGS

FIG. 1 shows tool 1 which by way of example will be described as an electric hand drill which utilizes the preferred embodiment of the invention.

FIG. 2 shows a simplified schematic diagram of the control mechanism for the FIG. 1 electric drill's D.C. electric motor.

FIG. 3 shows a simplified diagram demonstrating sensing tool position relative to the operator.

FIG. 4 shows a diagram of a tool and control responsive to tool position relative to the operator.

FIG. 5 shows a simplified diagram of sensing tool or work position relative to the operator used with a powered machine.

FIG. 6 shows a diagram of a tool or work and control of a powered machine in response to sensing of parameters relative to the operator and/or powered machine.

### DETAILED DESCRIPTION

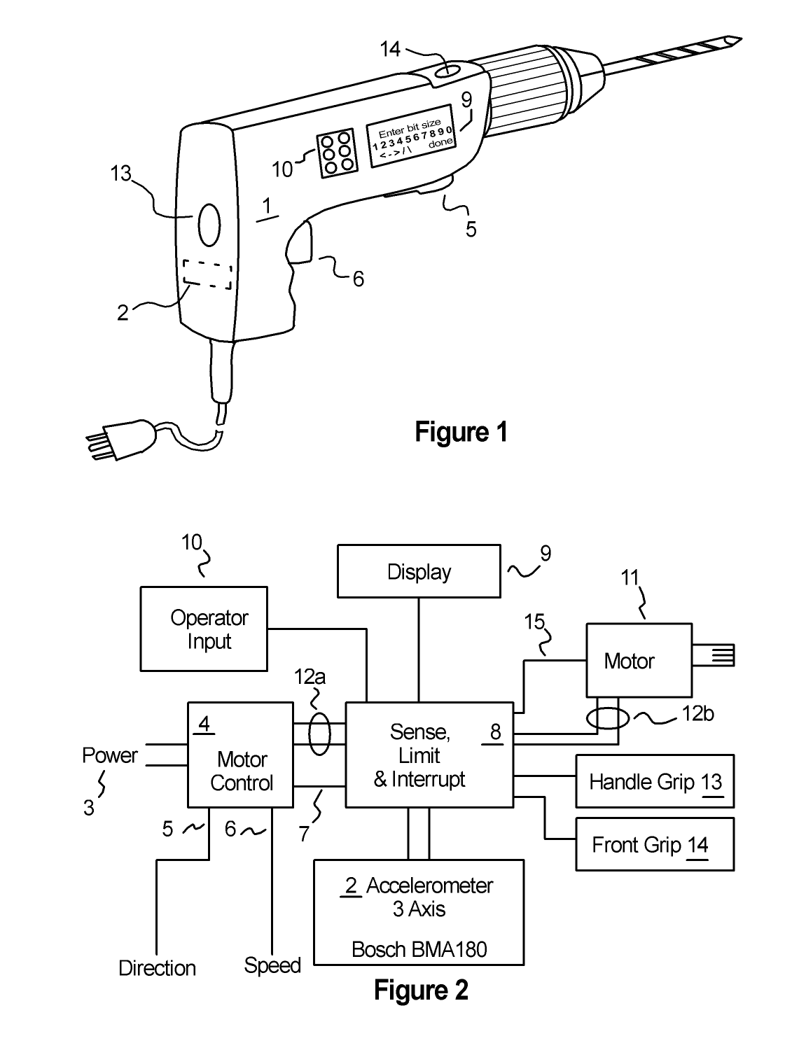

FIG. 1 shows tool 1 described by way of example an electric hand drill which utilizes the preferred embodiment of the invention. As is well known in the art the drill has a forward/reverse direction switch 5 and a variable speed (and/or variable torque) trigger 6. If desired, 6 may be modified to accommodate a bypass setting, for example when it is fully depressed, which bypass setting operates to prevent any limitation on motor torque or speed and/or to reengage the motor after it has been shut off or its torque or speed restricted by the invention. A separate bypass switch may be utilized if desired. In this manner the invention may be prevented from limiting the motor's torque or speed in situations where they operator desires to apply full power of the motor to the drill bit. Such operation will be useful in situations where the operator will be expecting a kickback but wants to have full power available to cause the bit to unstick. This is a frequent situation when a drill bit is about to break through a metal work piece. While shown as a hand drill for purposes of describing the preferred embodiment of the invention, it will be appreciated that 1 may represent any powered tool, or work which is utilized with a powered device, as will be described in more detail below.

The drill 1 also includes a three axis accelerometer 2 which is affixed to the drill, preferable inside the lower part of the handle, a hand grip sensor 13 and front grip sensor 14 as well as an LCD display 9 and operator input 10 such as a keypad which provides messages to the operator (9) and allows the operator to enter information (10). As is well known in the art other types of displays and inputs may be utilized for 9 and 10 if desired, e.g. a touchscreen type display if space permits. Sensors 13 and 14 may be implemented with electro/mechanical switches, pressure sensors, strain gauges, load cells, optical, capacitive or ultrasonic proximity sensors or the like as is known to persons of ordinary skill in the art. It may be noted that 13 and 14 differ from prior art type switches, sometimes referred to as dead man switches, which require the operator to hold a hand or foot on a switch to prevent tool operation otherwise as a safety measure. Sensors 13 and 14 are preferred to provide a measure of the quality of the operator's grip on the tool whereas a dead man's switch is intended to ensure that the operator's hands are safely out of the way of dangerous machinery and/or that the operator is present and alert.

While a one or two axis, spring-mass, optical acoustic, optical, capacitance, piezoelectric, servo, laser, magnetic, pendulous, resonance, surface acoustic wave (SAW), thermal or other type of accelerometer could be utilized for 2 to practice the invention, it is preferred that a three axis MEMS type accelerometer be utilized because of the low cost, low weight, high precision and speed which it provides. The Bosch BMA 180 available from Bosch Sensortec GmbH of Reutlingen, Germany is a suitable accelerometer for many applications of the invention. Three axis MEMS type accelerometers are commonly utilized in smart phones to (among other functions) allow the display to remain upright as the phone is tilted from vertical to horizontal. It will also be understood that while a single three axis measurement device is preferred, two or single axis devices may be utilized to provide single, two or three axis measurements if desired. Additionally, while the use of an accelerometer is preferred, the direct measurement of the force the tool presents to the operator may be performed (in 1, 2 or 3 axes) instead of or in addition to the acceleration measurements. Such force measurement is preferred to be accomplished by embedding force sensing devices in the hand grips of the tool and may be incorporated with 13 and 14. Such force sensors may be of any type known to the person of ordinary skill in the art from the teachings herein, e.g. strain gauges and load cells.

The preferred embodiment of the invention utilizes information provided by 2, 13 and 14 in order to determine the nature of the operator's grip on the tool (e.g. one or two hands being used) the angle of the tool (e.g. held vertically or horizontally) and uses this information to estimate the amount of force or acceleration which may be applied to the handle of the tool which the operator can safely hold. Additionally the sensor 2 provides acceleration information for the tool and in particular the acceleration of the handle if it should rotate in a direction opposite to the rotation of the bit indicating a stuck bit, or in a direction the same as the bit indicating a broken bit, or in a more complex manner. If the acceleration of the handle in any fashion is determined to be approaching a dangerous level, that is an amount of acceleration which if it continues or increases is likely to cause or has caused a force on the tool handle which the operator is unable to safely hold, then corrective action is undertaken. One simple corrective action is removing power from the tool's motor another is applying a brake, and another is disengaging the motor from the chuck (e.g. via a clutch) yet another is reversing the motor for a brief period of time followed by removing power. One or more of the actions may be performed simultaneously or sequentially. The motor may then be restarted by the operator by either releasing and then reapplying pressure to trigger 6, or by fully depressing 6 to the bypass position. It is preferred that the bypass position allows application of full motor torque without regard to the sensing of torque on the tool handle.

FIG. 2 shows a simplified diagram of the electrical control mechanism for a drill such as in FIG. 1 or other electric motor powered tool, which motor and control mechanism is described in respect to a DC motor for ease of understanding however it will be understood that AC may be utilized as well. Various interconnections are shown between the elements of FIG. 2 by single or double lines, however it will be understood that these lines may represent multiple unidirectional or bidirectional circuits of wired or wireless type as will be known to the person of ordinary skill in the art from the teachings herein. Other necessary parts, e.g. a power supply, and connections are omitted for simplicity however one of ordinary skill in the art will know to practice the invention from the teachings herein without resorting to undue experimentation or invention.

The FIG. 2 DC electric motor control mechanism has a power input 3 which may be from a power supply, battery, cord, fuel cell or otherwise as is known in the art. A motor control 4 having a direction input 5 and a speed and/or torque input 6, which motor control outputs current to drive the motor 11 via circuit 12a and 12b. A sense, limit & interrupt circuit 8 and associated circuitry is preferred to be included within the drill 1 according to the present invention, but may also be located external to the tool if desired. For the preferred embodiment the sense, limit & interrupt circuit 8 utilizes a microprocessor, non-volatile electronic memory including read only and read/write (or programmable) type, along with interface circuitry to interface with the various elements 2, 9, 10, 12a, 7, 13, 14 and 15 as will be described further herein. If desired, one or more processors, state machines, logic circuits or other electronic circuitry other than the preferred microprocessor may be utilized, particularly if it is desired to achieve cost or performance levels which are difficult with microprocessors. Control setting and other motor related information for example voltage, current, speed and torque are communicated via circuit 7 (or alternatively by 15 or a combination of 7 and 15) to the sense, limit & interrupt circuit 8. The sense, limit & interrupt circuit 8 receives input from the three axis accelerometer 2 and operator inputs from the operator input keypad 10, and outputs messages to the operator via display 9.

Operator input 10 and display 9 may be combined if desired, for example in the aforementioned touchscreen if space is available, such as those of the C-more Micro-Graphic Panel family provided by Automation Direct of Cumming, Ga. In many applications the touchscreen type device will be too expensive or not enough room is available for a reasonable size panel to be operated by the operator's fingers. Or an LCD or other optical display may be too expensive. Alternatively any of the many well-known technologies for inputting information and conveying messages to the operator (including aural) may be utilized if desired, or the input and/or display may be omitted, all as will be known to the person of ordinary skill in the art from the teachings herein. Operator input 10, if not combined with the display 9, is preferred to be implemented with electro/mechanical switches but may also be implemented with pressure sensing switches, optical, capacitive or ultrasonic proximity switches or the like as is known to persons of ordinary skill in the art. Display 9, if not combined with operator input 10, is preferred to be implemented with an LCD display, however other display types e.g. LED matrix, individual LED or beeper may be utilized as well. Such devices, as well as many of the electronic and electromechanical devices which may be utilized to practice the invention are available at Mouser Electronics of Mansfield, Tex.

Information may be stored for use by the sense, limit and interrupt circuitry in a semiconductor or other type of non-volatile memory which may be programmed at the time of manufacture with various characteristics of the drill, e.g. its mass, motor horsepower & speed and gearing. It is preferred that the operator enter desired operation parameters and modes via 10, for example limiting, bypassing or turning off limiting motor torque or speed limitations in response to unsafe operation, entering information about operator size and strength and skill level, entering a desired level of protection, as well as tool characteristics and configuration via 10. For example the operator may enter information as to whether an optional front handle has been attached to the drill which would allow sense, limit & interrupt 8 to ignore the front grip sensor 14 since the operator would be holding the front handle instead of the front grip. Alternatively sensor 14 may be moved to, or duplicated with another sensor mounted on the optional handle with the handle mounted grip sensor being utilized. The use of options such as the front handle may be automatically detected by switches or other sensors and coupled to 8 instead of requiring operator input via 10.

The sense, limit & interrupt circuit 8 also receives information about motor 11 via 15, for example excessive current indicating an impending or actual stall, and from the grip sensors 13 and 14. Sense, limit & interrupt 8 normally passes current supplied by motor control 4 via circuit 12a and on to the motor via 12b without alteration, however when undesirable acceleration, deceleration or other undesirable condition is sensed via 2, 13, 14 or 15 the current supplied to the motor 11 is limited, interrupted (e.g. disconnected) and/or reversed in order to limit and counteract the undesirable acceleration or deceleration. For example if the operator's grip as sensed by 13 or 14 is suddenly released while the drill is operating, the motor current may be immediately interrupted. Motor 11 is preferred to include temperature, torque and speed sensors as are well known in the art and to communicate information from those sensors via 15 to the sense, limit & interrupt circuit 8 to aid in determining undesirable motor conditions. Additionally motor 11 is preferred to have a brake which may be actuated by 8 via circuit 15 or by connection 12b from 4 and further to facilitate shorting or otherwise allowing current flow between conductors of one or more motor winding or otherwise as will be known to the person of ordinary skill in the art from the teachings herein. Further, in situations of unwanted sudden large accelerations of the drill handle it is preferred to briefly reverse motor direction to counteract the unwanted torque.

It should be noted that any braking (deceleration) or speed up (acceleration) of the motor and/or other rotating components will cause a reaction which couples force to the drill body and tends to move the body. The same is generally true of acceleration of rotating components and these forces are easily demonstrated by holding a drill at arm's length and quickly switching the drill direction from full forward speed to full reverse speed. The resulting reaction will result in the drill tending to rotate and thereby apply a twisting force to the extended arm. The amount of force is dependent on the amount of acceleration or deceleration. For example, the force coupled to the drill handle by braking a slowly turning motor is much less that the force resulting from braking a fast turning motor. The mass of the turning components is also directly related to the force which is created.

The amount of rotational acceleration of the drill handle for a given force can be used as a measure of the strength of the operator. If the switching of the drill direction (but not the test itself) is performed at random in singular or repeated fashion the rotational acceleration of the drill handle for a given force will also allow a measure of the operator's reaction time (reflexes). Strength measurements may be taken for various drill operating positions and operator grips if desired with the results being stored in memory, or a measurement may be taken for each new drilling position shortly before the drilling is commenced. In order to measure operator strength it is preferred that a known rotational torque profile, e.g. amount, change and time duration of torque as controlled by motor current and/or brake actuation, be applied to the handle with the movement of the handle being determined by the accelerometer. The movement is used as a measure of operator strength for the particular drill position and grip used for the test and data responsive to that data, and the position and grip if desired, are stored in memory for subsequent use in determining allowable kickback acceleration or force.

By performing the above described random switching from full forward (or some known) speed or torque to full reverse (or some known) speed or torque, or otherwise varying the speed and/or acceleration of the motor in a known fashion while the operator is holding the drill, a measure the operator's strength and reaction time can be determined by 8 and utilized to help determine the normal amounts of torque and/or drill body acceleration to be expected during work operations. This operator testing is preferred to be performed in the position that the operator will use for doing the actual drilling if that position and data is not already stored in memory. When the operator is in position to start drilling, circuit 8 will search memory for corresponding data. If the data does not exist circuit 8 signals the operator to perform a test for that position. The operator may initiate the test by simply pulling the trigger without the drill bit contacting, or only lightly contacting, the work and the test is run. The testing is preferred to take only a few seconds, which may be a fixed time or vary from test to test. While the operator will be aware of the random change in speed which takes place within the testing time, that change may nevertheless be utilized to measure reaction time and strength. Other testing methodology and routines may be utilized as desired.

For example given by way of aiding understanding the invention, if the drilling is to be done overhead, then circuit 8 checks for corresponding operator strength data for that position. If no data is found circuit 8 signals the operator, for example by an audible beep or by modifying the drill's response to a trigger pull. The operator would cause the drill to enter an operator test mode while holding the drill overhead with the bit near to or lightly contacting the work and actuating the trigger 6 but not actually drilling the work. The drill would perform a quick, randomly timed pattern of motor speed, acceleration and/or direction changes to test and determine the operator's strength and if desired reaction time when using the drill in this position. If desired a separate operator input control such as a push button or the like can be mounted to the drill to facilitate quick operator testing which can be utilized whenever no position data is found in memory, changing working position, drill bit, work or otherwise as desired. The operator testing, as well as the forces imparted to the drill handle while drilling the work are useful in helping to respond to unwanted operating conditions under control of 8. It is preferred that such forces, the resulting acceleration and/or the movement they tend to cause be calculated or measured and that resulting data is stored in the sense, limit & interrupt 8 memory in order that they may be utilized in determination of unwanted acceleration of the drill or utilized in determining any response to undesirable conditions as will be discussed in more detail below.

For further example given by way of aiding understanding of the invention, if the drill bit becomes stuck (or about to be stuck) causing the drill to begin to twist in the direction opposite to the bit's rotation, the excessive motor current from the stuck bit is sensed by 8, the accelerometer 2 senses the resulting drill body twist and depending on the magnitude of the twist causing acceleration circuit 8, taking into account the operator strength and reaction time, either limits the motor current, interrupts (e.g. shuts off) the current or reverses the motor in a controlled amount to cause kinetic energy stored in the rotating machinery to be dissipated (e.g. converted to heat or used to recharge the battery if any) and/or to reverse part or all of the unwanted rotational torque of the drill handle to keep that torque within the operator's strength and response time so the operator may maintain control of the drill. Because of the use of electronic circuitry for sensing and correction the above action may be performed very quickly, before appreciable velocity and resulting motion of the drill takes place.

In addition the motor brake may be actuated to assist in the protection, either before, during or after one or more of the aforementioned actions. For events where there is a quick acceleration of the drill handle it is preferred that the motor be instantly or quickly reversed until the unwanted acceleration is reduced to a safe level, stopped or even reversed, followed by removing power from the motor and braking the motor by shorting one or more motor winding or applying an electromechanical brake if provided, thereby allowing the operator to maintain control of the drill. For events where the motor suddenly accelerates after a stuck (or about to be stuck) condition such as when the bit breaks, the motor would be instantly or quickly stopped to keep the resulting rotational torque of the drill handle within the limits of the operator's strength and response time. Of course, the invention may be practiced without operator testing, with limited operator testing or with operator related parameters such as strength and response time input to 8 via 10 if the additional cost or complexity of testing is undesirable for a particular application of the invention.

If desired a controllable clutch or coupling (not shown) may be incorporated in the drill (at any desired location in the drive chain) to cause the drill bit to become uncoupled from the motor 11 thus limiting additional energy which is transferred to the drill bit and to aid in control of acceleration of the drill handle. In the event of using an addition of a clutch, care must be taken to prevent the motor and other internal rotating components from spinning uncontrollably to an excessive speed thus potentially causing internal damage. This clutch or coupling and associated protection is preferred to be controlled by 8 by disengaging the clutch or coupling, removing power from the motor and braking the motor by shorting or shunting one or more winding or applying a brake. These actions are preferred to occur simultaneously or nearly so, although one or more actions may be sequential to the others. Again the desired result of these operations is to keep the torque of the drill handle within the limits of the operator's strength and response time such that the movement of the drill handle is kept to a safe level.

As another example, assume that the drill bit suddenly breaks without a sticking (or about to be stuck) condition which will cause the drill to quickly accelerate and move from its position, most likely at least toward the work. The current drawn by the drill motor will quickly decrease and/or the motor RPM will quickly increase due to the suddenly reduced load. In addition the operator may not be able to react quickly enough to remove the force the operator is using on the drill which will cause the operator to undesirably rotate the drill and/or push the drill into the work. In this instance sense, limit & interrupt will determine the problem by monitoring motor current and acceleration of the drill in one or more direction. If the rotating components are oriented and have a sufficient mass that quickly accelerating or decelerating the motor can (due to gyroscopic forces) counteract the operators induced moving or turning of the drill that action is to be preferred to be performed while monitoring the drill movement to ensure that over correction is not caused and the drill handle torque remains within operator ability to control. If the rotating components are not so oriented, or do not have sufficient mass to counteract the operator induced movement then power to the motor is preferred to be quickly interrupted and rotation of the drill chuck promptly stopped by disengaging the clutch or coupling and/or braking as previously described. If desired, the orientation and mass of rotating components may be designed to facilitate such operation, or specific controllable rotary or linear masses may be incorporated to provide such counteraction.

Returning now to FIG. 1, it is seen that the drill has grip sensors 13 and 14 which are desired to sense how strongly (if at all) the drill is being gripped by each of the operator's hands. If the operator has both hands securely gripping the drill in the strongest manner the sensors will respond to and convey that information to the sense, limit & interrupt circuit 8 as shown in FIG. 2. At the other extreme, if on the operator only has a one hand grip on the handle or no grip at all, that information will also be conveyed. The grip information is preferred to be taken into account when performing operator testing. It is preferred that the grip sensors respond to not only the placement of the hands but to the intensity of the grip by measuring the force applied to the drill by the hand(s). Some drills have optional front handles (not shown) which may be affixed to or near the front of the drill. If desired a sensor which detects the presence of the front handle (or of any other option as desired) and communicates that presence to the sense, limit & interrupt circuit 8 may be incorporated and the optional grip may incorporate its own grip sensor 14 as previously discussed.

The sense, limit & interrupt circuit 8 is preferred to include an electronic microprocessor and interface components and circuits including electronic memory with the microprocessor executing a program stored in a portion of the memory and operating to respond to the various inputs from 2, 4 (e.g. via 7), 10, 13 and 14 as well as from the motor 11 (e.g. via circuit 15) and output messages to the operator via 9 as well as controlling the application and amount of current applied to the motor 11 to control the speed and/or torque thereof (and including reversing motor direction if desired) and the motor's brake if implemented, and the clutch if implemented in order to control the motor and the rotating components' speed, torque and stored energy thereby controlling motor rotation as well as torque and rotation of the drill to achieve the aforementioned protection. Circuit 8 is also preferred to perform the aforementioned operator testing and store desired information obtained from operator testing and various sensors, as well as to store information about the drill itself as well as information input by the operator via 10. Such information may be stored in any desired format or form. Circuit 8 may also be utilized to perform one or more testing routine for testing the drill and its components and to monitor drill operation for faults.

The 3 axis accelerometer is preferred to be a Bosch BMA180 which allows adjustable sensitivities of +/−1 g, 1.5 g, 2, 3 g, 4 g, 8 g and 16 g and includes lowpass, bandpass and highpass filters which may be selected by the microprocessor. The BMA 180 communicates with the microprocessor via I²C or 4 wire SPI communications and includes an interrupt output. It is preferred that the microprocessor of 8 operate to program various aspects of the BMA180 operation, for example sensitivities, in direct or indirect response to the operator's inputs and information about the drill and its operation thereby achieving optimum sensor performance. Other types of accelerometers may be utilized if desired, including devices which sense accelerations in only one axis or two axes, in order to achieve a particular desired level of cost, complexity and performance in practicing the invention.

It will also be recognized that it is desirable to provide for protection of the drill in the event the operator loses proper grip, e.g. turns loose of the handle or has the handle pulled from his grip, or changes grip (e.g. changes from two hand to one hand grip), the drill is dropped or dangerously operated, operated in a damaging manner, such as drilling in a manner that causes overheating, excessive speed for the bit being used, excessive current or voltage for the speed, or excessive vibration, chatter or wobble. In such instances the sense, limit & interrupt circuit 8 will alter the current supplied to the motor via 12b and brake via 15 as previously discussed in order to reduce or limit the problem or shut off current to the motor if necessary. A cooling apparatus such as a fan may also be operated by 8 in response to one or more of the aforementioned conditions, e.g. overheating. Circuit 8 may also be programmed to display via 9 suggested actions for the operator to take to help reduce or eliminate dangerous or damaging operation, for example by suggesting that the drill bit needs to be sharpened or that the drill needs to be allowed to cool off.

In operation it is desired that the operator be able to input information about the work being drilled such as the material being worked and how it is being worked. Examples of such information include bit type, bit size, bit hardness, bit speed, material type and material hardness. Circuit 8 is preferred to operate to utilize the supplied information to determine and control the proper operating speed and torque for the motor, as well as the maximum safe acceleration profile for a given drill position, orientation, speed and operator grip. In the event the acceleration profile is exceeded it is desired that circuit 8 operate to limit, interrupt or reverse current applied to the motor 11 via 1 2b and/or brake via 15 or otherwise. In the event of a change of conditions such as a change of the operator's grip, or developing mechanical conditions such as the aforementioned operation in a damaging manner it is preferred that a new proper motor operating speed and torque, as well as a new maximum safe acceleration profile are determined by circuit 8.

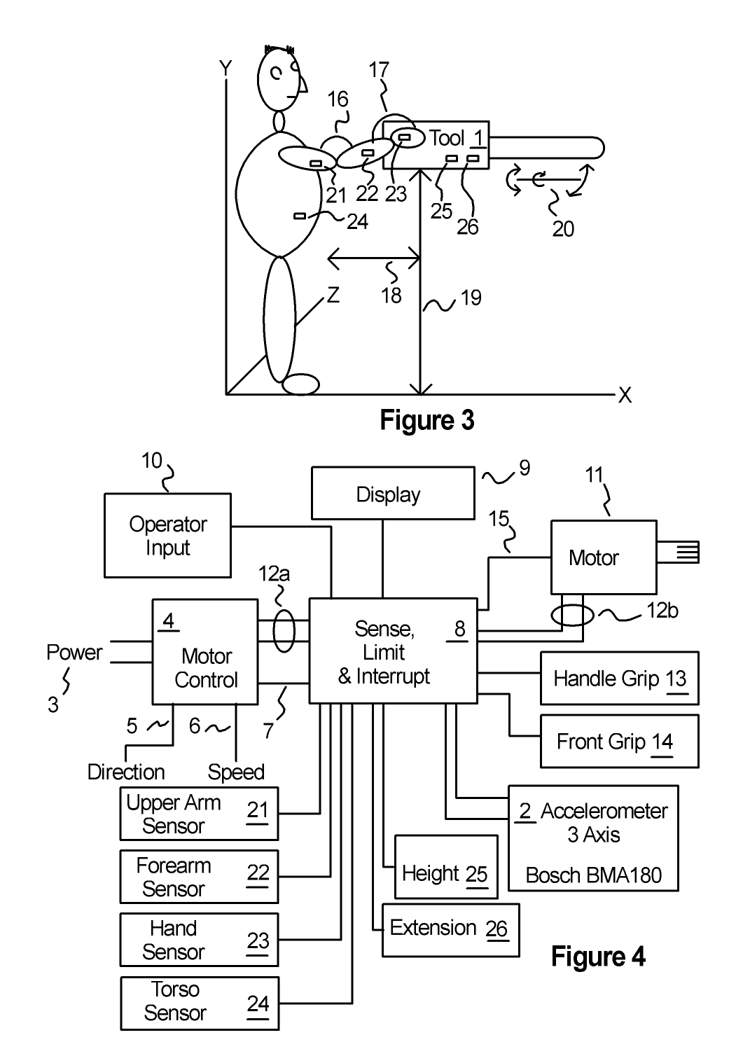

FIG. 3 shows a simplified diagram demonstrating by way of example a further embodiment of the present invention utilizing sensing of tool position relative to the operator. A chain saw type tool 1 is utilized by way of example but the teachings will be understood to applicable to other tools held by an operator which may experience kickbacks. In this further embodiment it is preferred that several tool holding position parameters are sensed including elbow angle 16, wrist angle 17, distance of tool center of gravity from operator 18 (also called extension), and height above ground of tool center of gravity 19. Additionally it is preferred to sense the tool's major axis' angular position relative to gravity in three axes as shown by 20. For example, as shown from the operator's perspective in FIG. 3 the three axes 20 include angle of the tool left and right, the angle of the tool up and down and the twist of the tool clockwise and counterclockwise. Explained another way, if the X,Y,Z origin is moved to coincide with the tool's center of gravity, the three positions are tool left/right angle or rotating around the Y axis, tool up and down angle or rotating around the Z axis and tool twist or rotating about the X axis.

By use of trigonometric relationships it is possible that by knowing the two angles 16 and 17 and the distance of the operator's arm from shoulder to ground, shoulder to elbow and elbow to hand, and assuming a lack of bending or kneeling and the operator having a two hand tool grip, the position of the tool in 2 dimensions, X and Y in the diagram relative to the operator can be calculated. By adding parameters 18, 19 and 20 the X and Y position and angles of the tool relative to the operator may be determined relatively independent of the tool grip and arm bending or kneeling action if desired. Other parameters may be sensed and communicated to the tool as desired as will be discussed in more detail below and by use of trigonometric relationships those parameters may be utilized to determine or approximate other parameters. It is preferred that the information 16-20 (or 18-20 if desired) of FIG. 3 be obtained by use of sensors wired or wirelessly communicating with or otherwise associated with the tool. The sensors may be physically attached to or otherwise associated with the operator or otherwise configured to provide the desired information to the tool 1 as will become apparent to the person of ordinary skill in the art from the more detail description herein.

The determination of tool angular position relative to gravity 20 is preferred to be performed in conjunction with a 3 axis accelerometer 2 mounted to the tool 1 as previously described. The determination of the distance of tool center of gravity from operator 18 and height of tool center of gravity above ground 19 are preferred to be determined by individual height sensor 25 and extension sensor 26 which are mounted to or otherwise associated with and wired or wirelessly communicating with the tool. Ultrasonic sensors may be employed for these measurements as is well known in the art, for example the MaxSonar EZ-1 sensor available from MaxBotix Inc. of Brainerd, Minn. wireless locators may be employed instead for the extension or height measurement. For example, wireless technology such as two or three dimensional RADAR, optical or ultrasonic emitters and sensors may be utilized. The wireless locator is preferred to utilize a target device worn by the operator, for example attached to the operator's belt. Alternatively, the extension sensor may be worn by or associated with the operator with the target located at the tool. The aforementioned configurations will provide a high degree of precision in making extension measurement. Other configurations for sensing tool, work and/or operator position relative to gravity, operator and/or a separate device may be utilized if desired, examples of which will be discussed in more detail below by way of example to aid in the understanding of the invention.

The elbow angle 16 and wrist angle 17 (and any other desired joint angles) are preferred to be determined in conjunction with sensors 21-24 which are worn by, attached to or otherwise associated with the operator and communicate wirelessly with the sense, limit and interrupt circuit 8. While it would be possible to attach an angle sensor across each joint for which it is desired to know the joint angle, for convenience it is preferred that individual angle sensors which measure the angle of the part of the arm and the hand with respect to gravity be worn. In this manner the angle of various body parts, in this example the upper arm, forearm and hand can be determined and communicated to the tool. With these three angles the joint angles for the elbow and wrist may be determined as well by use of trigonometric relationships. Thus an upper arm sensor 21, forearm sensor 22, hand sensor 23 and torso sensor 24, which are worn by, attached to or otherwise associated with the operator, each operate to sense and wirelessly communicate the angle of the respective body part with respect to gravity to the sense, limit & interrupt circuit 8 and from that information the angles of the torso, shoulder, upper arm, elbow, forearm, wrist and hand may be determined and used to ensure safe tool operation as well as to protect the operator from undesired tool movement.

With respect to sensors including 21-24 which are preferred to be worn by, attached to or otherwise associated with the operator, such sensors are desired to be located with respect to the particular body part which they are intended to sense. Applicant envisions the use of flexible bands with fasteners such as buckles or snaps, similar to watch bands, to facilitate fastening, however elastic bands, adhesive pads such as those used for medical EKG device electrodes, adhesive applied directly to the sensor, and other fastening methods as are known in the various arts requiring fastening of devices to humans may be utilized. In respect to the use of sensors associated with an operator, it is also envisioned that the sensors may be affixed to an article of clothing or a protective device such as a vest or pad which is worn by the operator. For example 21-23 may be affixed to a shirt, jacket or protective cover sleeve. Sensor 24 may also be affixed to a belt.

Other manners of obtaining the sensor information may be resorted to as will be known from the teachings herein, for example by combining sensors to determine or approximate both angle of joints and angles of body parts by use of trigonometric relationships. Sensors associated with the operator and/or work and/or tool include one or more video camera which view the operator body part(s) (and/or the tool and work) coupled with computerized image recognition and morphological processing. These sensors may be utilized to obtain some of all of the preferred data pertaining to 16-20 as desired. The system may operate with the attachment of active or passive markers to the operator and/or tool and/or work as desired, which markers facilitate the image recognition and morphological processing operations. Passive markers, for example include retroreflective devices, operate to reflect a light located at the camera lens directly back to the camera lens. Road signs for vehicle drivers commonly utilize retroreflective techniques for improved night visibility. Active markers, for example devices with LED lights, improve the imaging processing ability to detect points on the captured image. The system may also operate without markers, what is referred to as a markerless system.

Motion capture systems such as those provided by bioengineering companies and used to analyze movements of athletes, performers and the like may be suitably adapted in replacement of, one or more of the sensors 21-24, as well as for 25 and 26 if desired, or to operate along with ones of those sensors. The data pertaining to desired ones of angles 16, 17 and the torso, the distances 18 and 19, as well as angles 20 may be obtained and provided to sense, limit & interrupt circuit 8 in wired or wireless fashion. This data may then be utilized by circuit 8 to determine the manner in which the tool 1 is being operated by, and relative to, the operator. Information about the tool, e.g. weight and tool type, which is stored in memory may also be utilized by circuit 8 for this purpose.

Additionally, for some tools it will be desirable to program ones of the operator's physical characteristics, e.g. height, arm length, weight, strength, reaction time and the like into the sense, limit & interrupt circuit 8 via the operator input 10 in order to facilitate safe tool operation calculations and measurements, however a suitable approximation may also be had by using average dimensions for the population of the country or region where the tool is expected to be utilized. The average dimensions may be separated into one or more groupings, e.g. male and female, with the corresponding grouping for a particular operator being entered via operator input 10. Further, the above described motion capture systems may be designed to incorporate the ability to analyze images of the operator and provide one or more of the desired physical dimensions.

From the above described sensor information and angles 16,17 and 20 it is possible to accurately determine or approximate the distance of the tool from the torso 18, and the height of the tool above ground 19. In some applications it will be desired to provide separate sensors for one or both of these dimensions as indicated by 25 and 26 with 25 providing the height above ground 19 and 26 providing the distance from the operator 18. The aforementioned ultrasonic devices are one example of sensors usable for 25 and 26 which will allow measurement of distances 18 and 19 directly. Operator position relative to ground or tool position relative to the operator, or tool position relative to ground or any combination thereof may be sensed and/or determined and communicated to the tool for use by itself or in conjunction with other information in protecting the operator. Other suitable sensors which may be utilized for 25 and/or 26, as well as for determining the angles 16,17 and 20 will be known to the person of ordinary skill in the art from the teachings herein. It is preferred that this information be utilized by circuit 8 in determining whether the operation of the tool is safe or unsafe, or the degree thereof. This information may also be utilized to determine if operation is approaching an unsafe operation.

FIG. 4, similar to FIG. 2 with added sensors 21-26, shows a block diagram of the preferred embodiment of the invention when operated in conjunction with an electric motor powered hand tool. The additional sensors 21-26 are incorporated and provide information to the sense, limit & interrupt circuit 8 as discussed above. Sensors 21-24 are preferred to operate to allow circuit 8 to determine angles of the upper arm, forearm, hand and torso respectively as previously described with the data to facilitate determination of that angle information communicated to circuit 8. From this information and the operator's arm length and height the distances 18 and 19 may be determined or approximated. If desired, height and extension sensors 25 and 26 may be provided in addition to or instead of ones of sensors 21-24 to provide height and extension information to 8 as will be known from the present teachings. The 3 axis sensor 2 (FIG. 1) which is preferred to be mounted to or otherwise associated with the tool 1 along with 25 and 26 provides data to 8 which facilitates determination of tool angle information and in particular is preferred to provide information which allows 8 to determine the angle with respect to gravity at which the tool is being held. Further, grip sensors 13 and 14 which are preferred to be mounted to or otherwise associated with the tool 1 are also provided to provide grip information to circuit 8.

With the inclusion of aforementioned sensors 2, 13, 14 and 21-26 the sense, limit & interrupt circuit 8 will be provided real time or near real time information from which it may determine the operating position of the tool 1, and if desired, its distance from ground and the operator, the operator's grip and how the tool is being held, i.e. the position of the tool relative to the operator. In addition operator information may be provided by operator test and/or operator input via 10 as well as tool information with this information being stored in memory as previously described. In this manner circuit 8, in conjunction with information about the operator and tool which is stored in memory and the real time or near real time operation of the tool from 2, 13, 14, 21-26 and from 5, 6 and 15, can determine the limits of tool acceleration which represent safe operation as well as actual tool operation acceleration relative to that safe operation and thereby control the tool motor, clutch (if provided) and brake (if provided) to maintain safe operation or otherwise reduce or prevent unsafe operation.

It will be appreciated that while the tool acceleration measured while the tool is being operated is a good measure of the degree of safe operation and thus the operator's ability to control the tool during a kickback event as previously described, it is also possible to limit the kinetic (and static) energy the tool is developing during operation in order to further protect against unsafe events. For example if the operator is holding the tool overhead a portion of the operator's strength is being used for that holding, thus reducing the remaining available strength to cope with a kickback. If the moving mass of the tool is known, the velocity of that mass, e.g. the RPM of the tool motor, may be limited so that in the event of a stuck bit or other kickback causing event the amount of energy imparted to the kickback is limited thus giving the operator a better ability to cope with the situation without losing control of the tool. Using information about the operator strength, tool type, mass, rotating mass and tool operation, circuit 8 may determine the permissible motor RPM for a given set of operating criteria. One of ordinary skill in the art will know how to practice the invention to incorporate these inventive features from the teachings herein without resorting to undue experimentation or invention.

Thus, with the above information provided to sense, limit & interrupt circuit 8 the position of the tool relative to the operator, e.g. close, extended, low, high, pointed up, pointed down as well as the operator's position, e.g. standing, crouching, leaning can be determined or estimated. This information may then be used to help prevent the tool from exceeding the operator's ability to hold the tool, both for normal operation and for unexpected kickback type events in response to the particular tool position relative to the operator and accordingly to limit the forces required to hold the tool to those which the operator may safely handle to ensure safe tool operation as well as to protect the operator and bystanders from undesired tool movement. The control may include control of the current (e.g. power) to motor 11, application of brake if provided and disengagement of clutch if provided in order to limit or otherwise control tool operation and correct for potentially or actual dangerous operation as described herein and as will be further known to the person of ordinary skill in the art from the present teachings.

It will be appreciated that the operation described with respect to FIG. 4 is shown with inputs 5 and 6, sensors 2, 13, 14 and 21-26 display 9, operator input 10, communications with motor control via 7 and motor via 15, however it will be understood that any combination of these elements and their functions may be omitted, restructured, replaced or combined as desired to practice the invention to achieve a particular level of cost, complexity, performance and safety. If desired sensors operating with one or more of 4, 11, 12a or 12b may communicate with 8 to provide information which in the preferred embodiment is communicated via 7 and 15. For example current sensors may be coupled directly to 12a or 12b to provide current information directly to 8. In a simplified form which is envisioned to have commercial value the only sensor would be a single MEMS accelerometer 2 which senses acceleration of the tool handle in the direction opposite to chuck rotation and when that acceleration reaches a predetermined amount 8 operates to interrupt current to the motor. More complex embodiments may add one or more other sensors and features such as a trigger 6 with a bypass position (or separate bypass switch, sensor or setting) as well as those shown in FIG. 4.

In more complex embodiments of the invention operator sensors may be utilized. These sensors may be affixed to the skin (tape, adhesive), worn with one or more articles of clothing (sewn in, glued or otherwise affixed to) affixed to mechanical devices which are themselves worn or affixed to body parts, e.g. gloves, jackets, braces, assistive devices, exoskeletons or strength assist devices. In operations where the operator is assisted by hydraulic or other machines in the handling heavy or large tools the sensors may be desired to be affixed to those devices at the handle, steering wheel, joystick or other operator control in order to sense the operator grip and hand position. Additionally it is envisioned that 2D or 3D optical devices such as television cameras and scanners may be utilized along with pattern recognition and morphological processing software running on the microprocessor of 8 or another computing device to perform sensing and measurement of the operator, tool and/or work position.

Similar to FIG. 2, the sense, limit & interrupt circuit 8 of FIG. 4 is preferred to include an electronic microprocessor, non-volatile electronic memory including read only and read/write (or programmable) type and interface components and circuits with the microprocessor executing a program stored in memory and operating to interface with the various elements 2, 9, 10, 7 (and/or 12a), 13-15 and 21-26, as well as from the motor 11 (e.g. via circuit 15), output messages to the operator via 9 and receive operator input via 10 as well as controlling the application and amount of current applied to the motor 11 to control the speed and/or torque thereof (and including reversing motor direction if desired) and the motor's brake if implemented, in order to control motor and rotating components' speed, torque and stored energy thereby controlling motor rotation as well as torque and rotation of the drill to achieve the aforementioned protection.

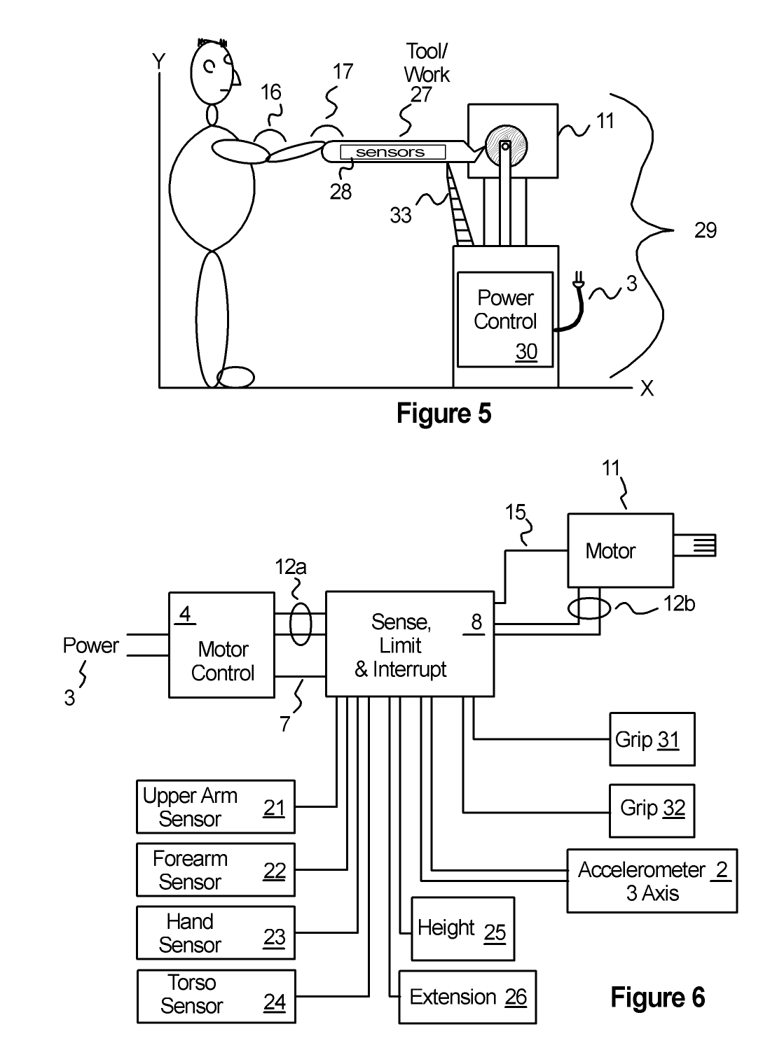

FIG. 5 shows a diagram explaining by way of example how the invention may be practiced with a powered or unpowered tool or work 27 which is operated by the operator in conjunction with a powered machine 11, shown by way of example as a wood lathe 29 (which may be configured as a grinder as is well known in the wood turning art) having a motor 11 and power control circuit 30 responsive to input power 3 to control operation of motor 11. When operated as a wood lathe 27 is a cutting tool and when operated as a grinder 27 is the work. Although 29 is shown for example as electrically powered, it will be understood that the invention may be practiced with any type of powered machine e.g. steam, hydraulic and internal combustion. Sensors 28 similar to the desired ones of those previously described are preferred to be affixed to the tool or work 27 by any convenient means which will allow the position of 27 to be determined relative to the operator and/or gravity. If desired, ones of the sensors may be affixed to the powered machine 29, for example one or more tool angle sensor or a tool force sensor to measure the tool angle and pressure exerted on the tool by the rotating lathe (or grinder) may be affixed to the tool support 33. In addition for purposes of the present teachings by way of example the powered machine 29 is described as situated on the floor and thus it is possible to determine the position of the tool or work 27 with respect to the machine.

It is further preferred that sensors 28 include grip sensors 31 and 32 (not individually shown in FIG. 5) that are particular to the features of the tool or work 27 thus allowing sensing of the operator's grip thereon by each hand. Alternatively grip sensors 31 and 32 may be attached to or otherwise incorporated with devices attached to or worn by the operator, for example in a wrist band or gloves worn by the operator. In this fashion the operator's grip on the tool may be determined in a fashion similar to that described with respect to the handle grip 13 and front grip 14 of FIGS. 1-4, as well as being used to determine the loss of grip by one or both hands. For example if either hand loses, mispositions or weakens its grip while the tool is operating the tool may be automatically shut off. Additionally the operator position, e.g. 16,17,18 and 19 etc. may be monitored by use desired ones of sensors 21-26 as previously described. Furthermore, it is preferred that the power control 30 incorporates sense, limit & interrupt circuitry 8 responsive to various operator, motor control, motor and position sensors similar to that described with respect to FIG. 4 as will be described in more detail with respect to FIG. 6.

FIG. 6 shows a block diagram of the preferred embodiment of the invention when operated in conjunction with the aforementioned powered machine 29 of FIG. 5. Some elements shown in FIGS. 2 and 4 are not shown, e.g. operator input and display, but may be incorporated if desired. Sensors 21-24 are preferred to determine angles of the upper arm, forearm, hand and torso respectively as previously described with that angle information communicated to the sense, limit & interrupt circuit 8. If desired, height and extension sensors 25 and 26 may be provided in addition to or instead of sensors 21-24 to provide height and extension information to 8. The 3 axis sensor 2 which is preferred to be mounted to the tool or work 27 along with 25 and 26 and part of sensors 28 provides tool angle information to 8 and in particular is preferred to provide information which allows 8 to determine the angle with respect to gravity at which the tool is being held, the position of the tool or work relative to the operator and relative to the powered machine. Further grip sensors 31 and 32, part of sensors 28 are preferred to be mounted to the tool or work 27 but may also be associated with the operator and provide grip information to 8.

FIG. 6 also shows a power input 3, motor control 4 and motor 11 with the motor controller 4 operating to provide power to the motor via 12a and 1 2b. The motor control is preferred to communicate with sense, limit & interrupt circuit 8 as is the motor via 15. It is preferred that the elements 4 and 8 be contained within a power control device 30 of FIG. 5 with the motor 11 being the mechanical power source for the powered machine 29. Accordingly control of the motor 11 may be achieved in response to the various inputs from the sensors in order to provide operator safety as described herein. In particular sense, limit & interrupt circuit 8 may determine if the operator is holding the tool or work 27 in a proper manner given the running conditions of the powered machine 29 and limit or otherwise control motor 11 and its brake and clutch (if provided) to reduce the possibility of potential injury arising from potentially dangerous operation caused by the position and force of the tool or work 27 or to limit any potential injury in the event a dangerous operation is entered.

One of ordinary skill in the art will recognize from the present teachings that the invention may be utilized in respect to powered machines even though the operator is not directly holding the tool or work. As one example if the powered machine of FIG. 5 were to be utilized with a tool or work 27 which was mounted to the tool support 33 in a manner such that the operator was not required to hold the tool or work, sensors could nevertheless be utilized to monitor the tool's position and the force applied to the tool via support 33 along with other factors such as acceleration of 27 to determine when an unsafe condition was present. For example if a tool 27 became dull during operation the pressure applied to the tool via support 33 would increase, possibly to an amount which might cause danger of the tool breaking or the work in the lathe coming free of the lathe and flying through the air. Forces such as forces on tool or work 27, or other forces which it is desired for circuit 8 to be responsive to, may be determined in any manner known to the person of ordinary skill in the art from the teachings herein, e.g. strain gauges or load cells.

It will be noted that the elements of the preferred embodiment, their structure, interconnections and cooperation are given by way of example and may be altered or modified or other elements utilized as will be known to the person of ordinary skill in the art from the teachings herein without departing from the skill and scope of the invention as hereinafter claimed. While the preferred electronic circuit elements have been described by way of example, with those element operating in cooperation thus facilitating the sense, limit and interrupt circuit to make determinations of safe and unsafe operation by electronic calculations, such determinations may be made by other elements and methods and one of ordinary skill in the art will recognize that elements and combinations thereof may be implemented in other forms as will be known to one or ordinary skill in the art from the teachings herein in order to achieve a particular level of cost, performance and/or safety, including with the use of analog or digital electronic circuitry, one or more of discrete, SSI, MSI, LSI, VLSI, FPGA, ASIC, RISC, DSP and IP Core electronic circuitry and/or optical, pneumatic, hydraulic and mechanical circuit elements and devices.

In particular elements, circuits and interconnections are shown in simplified form such as a single 3 axis accelerometer, single grip sensors for the handle and drill front, separate motor control and sense, limit & interrupt circuit, single interconnection circuits and the like, any or all of which may be combined, paralleled, separated or implemented in a plurality of elements. It has heretofore been described that the invention operates to reduce dangerous situations or injury by control of the motor providing the power which can ultimately lead to the injury. It will be appreciated however that other manners of reducing risk of injury may be resorted to as will be known from the teachings herein, for example by the control of shields, cooling, energy adsorbing devices and the like, or by various warning mechanisms designed to alert the operator to potential or actual unsafe conditions.

I claim:

1. A method of limiting unwanted movement of a power tool comprising:
providing acceleration parameters within which a power tool may be safely operated and storing said acceleration parameters in a memory device;
measuring acceleration of said power tool during operation with a 3-axis accelerometer attached to said power tool;
evaluating said acceleration in respect to said acceleration parameters using a processor executing a program also stored in said memory device, said processor in data communication with said 3-axis accelerometer;
interrupting power supplied to said power tool when an unsafe operation is determined.

2. The method of claim 1 wherein said processor is an electronic digital microprocessor or microcontroller.

3. The method of claim 1 wherein said memory device is an electronic memory.

4. The method of claim 1 wherein said 3-axis accelerometer is a MEMS accelerometer.

5. The method of claim 1 further comprising reversing said power tool when an unsafe operation is determined.

6. The method of claim 1 wherein said power tool is chosen from the group consisting of a drill, a table saw, a chain saw and a grinder.

7. The method of claim 1 wherein said stored program accounts for gravity in determining if an unsafe condition exits.

8. The method of claim 1 further comprising providing parameters representing tool mass, tool grip and tool operation.

9. The method of claim 1 further comprising providing parameters representing an operator's ability to hold said power tool at a plurality of angles with respect to gravity.

10. A safety system for disabling a power tool in response to an unsafe dynamic operating condition comprising:
a processor in proximity to said power tool, said processor in electrical communication with one or more storage devices;
a 3-axis accelerometer adapted to be attached to a power tool, said 3-axis accelerometer in data communication with said processor;
a set of acceleration parameters stored in said storage device, said acceleration parameters related safe operating limits for said power tool;
a power cutoff switch cooperating with said tool and under control of said processor;
a set of executable instructions also in one or more of said storage devices and executing on said processor so that acceleration data from said accelerometer can be compared with said set of acceleration parameters to determine safe operation of said tool, said executable instructions adapted to activate said power cutoff switch removing power from said power tool if an unsafe condition is determined.

11. The safety system of claim 10 wherein said processor is an electronic digital microprocessor or microcontroller.

12. The safety system of claim 10 wherein said memory device is an electronic memory.

13. The safety system of claim 10 wherein said 3-axis accelerometer is a MEMS accelerometer.

14. The safety system of claim 10 wherein said power tool is chosen from the group consisting of a drill, a table saw, a chain saw and a grinder.

15. The safety system of claim 10 wherein said set of executable instructions accounts for gravity in determining if an unsafe condition exits.

16. The safety system of claim 10 further comprising parameters representing tool mass, tool grip and tool operation stored in one or more of said storage devices.

17. The safety system of claim 10 further comprising parameters representing an operator's ability to hold said power tool at a plurality of angles with respect to gravity stored in one or more of said storage devices.

18. The safety system of claim 10 further comprising a hand grip sensor in data communication with said processor.

19. The safety system of claim 10 further comprising a front grip sensor in data communication with said processor.

20. The safety system of claim 10 wherein said data communication is wireless.

21. The safety system of claim 10 further comprising a reversing switch cooperating with said power tool under control of said processor, whereby said processor can reverse said power tool when an unsafe condition is determined.

22. A safety device for preventing operator injury from excessive force or acceleration from a power tool comprising, in combination:
a processor executing a stored program;
a 3-axis accelerometer configured to be attached to a power tool, said 3-axis accelerometer adapted to communicate acceleration data from said power tool to said processor;
wherein said stored program evaluates said acceleration data from said power tool against a set of pre-stored safe acceleration conditions to determine an unsafe operating condition of said power tool;
a power cut-off switch under control of said processor controlling power to said power tool, wherein said processor activates said power cut-off switch upon determining an unsafe operating condition therefore disabling said power tool.

23. The safety device of claim 22 further comprising a wireless communication module adapted to wirelessly communicate acceleration data from said 3-axis accelerometer to said processor.

24. The safety device of claim 22 further comprising a hand grip sensor in data communication with said processor.

25. The safety device of claim 22 further comprising a front grip sensor in data communication with said processor.

26. The safety device of claim 22 further comprising a reversing switch under control of said processor and in cooperation with said power tool, whereby said processor can reverse said power tool when an unsafe operating condition is determined.
